(19) United States
(12) Patent Application Publication
(10) Pub. No.: US 2011/0307613 A1
(43) Pub. Date: Dec. 15, 2011

(54) APPARATUS AND METHOD FOR INTEGRATED MANAGEMENT OF DIGITALIZED INFORMATION AND DYNAMIC RESOURCES OF BUILDING

(75) Inventors: Ji Yeon SON, Daejeon (KR); Ji Hyun LEE, Daegu (KR); Young Sung SON, Daejeon (KR); Hark Jin LEE, Gumi (KR); Jun Hee PARK, Daejeon (KR); Kyeong Deok MOON, Daejeon (KR)

(73) Assignee: Electronics and Telecommunications Research Institute, Daejeon (KR)

(21) Appl. No.: 13/158,160

(22) Filed: Jun. 10, 2011

(30) Foreign Application Priority Data
Jun. 11, 2010 (KR) 10-2010-0055674
May 30, 2011 (KR) 10-2011-0051434

(51) Int. Cl. G06F 15/173

(52) U.S. Cl. 709/226

(57) ABSTRACT

Disclosed are an apparatus and a method for integrated management of digitalized information and dynamic resources of a building, in order to integrate and manage digital information associated with a building and information on resources dynamically managed, such as various sensors and devices, networks, services, and the like in the building built up in a building designing or construction stage, resource objects are generated for each of the digitalized building information and dynamic resource information collected from one or more dynamic resources associated with the building, and a list thereof is maintained and managed, and an integrated map of a resource relationship object representing a relationship between the resource objects is generated, maintained, and managed on the basis of the list.

### CROSS-REFERENCE TO RELATED APPLICATIONS

This application claims priority under 35 U.S.C. §119 to Korean Patent Application Nos. 10-2010-0055674, filed on Jun. 11, 2010 and 10-2011-0051434, filed on May 30, 2011, in the Korean Intellectual Property Office, the disclosure of which is incorporated herein by reference in its entirety.

### TECHNICAL FIELD

The present invention relates to an apparatus and a method for integrated management of digitalized information and dynamic resources of a building, and more particularly, to a method and an apparatus that integrate digital information associated with a building and information on resources dynamically varying, such as various sensors and devices, networks, services, and the like in the building built up in a building design or a construction stage.

### BACKGROUND

As construction industry becomes bigger, complicated, and unstandardized, focus of the information management of construction industry is changing from design drawings to building information in order to improve quality in design and construction stages and enhance maintenance and management. Digitalized building information may include various attribute information associated with the building in addition to spatial and structural information of the building, and information on various facilities such as electrical and cable wirings, gas pipes, and fire protection facilities. Accordingly, digitalized building information can be variously utilized from a planning stage of a new building to design, construction, and maintenance stages.

However, the building information primarily includes information associated with the design and construction stages and does not include dynamic monitoring information of the resources such as various devices, networks, services, and the like, which also are management targets in the building.

Further, since the existing resource management methods collect and manage only monitoring information of individual resources, it is difficult to determine how the resources are physically or structurally associated with each other.

### SUMMARY

In the present invention, resource objects are generated for each of digitalized building information and dynamic resource information collected from one or more dynamic resources associated with a building, and a list thereof is maintained and managed, and an integrated map of a resource relationship object representing a relationship between the resource objects is maintained and managed on the basis of the list.

According to an aspect of the present invention, there is provided an apparatus for integrated management of digitalized information and dynamic resources of a building, including: a resource information collector collecting dynamic resource information from one or more dynamic resources associated with the building; an individual resource managing unit receiving digitalized building information from a building information storage to generate a building resource object corresponding to a building resource in the received building information, storing and managing a list of the generated building resource object in a storage device, generating a dynamic resource object corresponding to the dynamic resource information collected by the resource information collector, and storing and managing a list of the generated dynamic resource object in the storage device; and a resource integrating unit connected with the individual resource managing unit to generate and manage a relationship between the building resource object and the dynamic resource object.

The building information storage may be provided inside or outside the building information managing apparatus and the dynamic resource may include at least one of a device, a network, and a service.

The apparatus may further include a user input interface receiving the building information or the dynamic resource information from a user.

Each of the building resource object and the dynamic resource object may include resource object common information, which is common for all the resources, and resource specific information, which is unique for each resource.

The resource object common information may include a resource object ID, an object type, and an object name.

The resource specific information may include at least one of an absolute position coordinate value, a class, and internal relationship information in the case of the building resource object.

The resource specific information may include at least one of a device state, a hardware address, an access authority, and a physical position when the dynamic resource object is a device, and the resource specific information may include at least one of a network link ID, a link type, a parent/child link, a maximum bandwidth, a link state, an error rate, and traffic information when the dynamic resource object is a network.

The resource integrating unit may perform automatic or manual mapping of physical space information of the dynamic resource object with the building information.

The resource integrating unit may generate a resource relationship object representing a relationship between two or more resource objects, and store and manage an integrated map of the generated resource relationship objects in the storage device, and the resource relationship object may include basic resource relationship object information, a source resource object, and a target resource object list.

When a message is received from the resource information collector, the individual resource managing unit may analyze the received message and retrieve the dynamic resource object corresponding to the message from the list of the dynamic resource object and update the list of the dynamic resource object using information included in the message, and, when the message includes spatial information of the dynamic resource object, the resource integrating unit may verify whether a spatial information name corresponding to a name of the spatial information is present in the list of the building resource object, and, when the corresponding spatial information name is present, the resource integrating unit may set an spatial information ID of the dynamic resource object as a spatial information ID matched in the list of the building resource object.

When physical space information of a predetermined dynamic resource object is input from outside of the individual resource managing unit, the individual resource managing unit may verify whether a building resource object corresponding to the physical space information is present in the list of the building resource object, and, when the corresponding building resource object is present, the individual resource managing unit may retrieve the predetermined resource object from the list of the dynamic resource object and set a physical space ID of the retrieved predetermined resource object as the spatial information ID of the building resource object.

According to another aspect of the present invention, there is provided a method for integrated management of digitalized information and dynamic resources of a building, including: receiving digitalized building information from a building information storage; generating a building resource object corresponding to a building resource in the received building information and storing a list of the generated building resource object in a storage device; collecting dynamic resource information from one or more dynamic resources associated with the building; generating a dynamic resource object corresponding to the collected dynamic resource information and storing a list of the generated dynamic resource object in the storage device; and generating a resource relationship object representing a relationship between the building resource object and the dynamic resource object and storing an integrated map of the generated resource relationship object in the storage device.

The method may further include automatically or manually mapping physical space information of the dynamic resource object with the building information.

Other features and aspects will be apparent from the following detailed description, the drawings, and the claims.

### BRIEF DESCRIPTION OF THE DRAWINGS

FIG. 1 is a diagram showing an overall configuration of a system for integrating digitalized building information and dynamic resource information in a building according to an exemplary embodiment of the present invention.

FIG. 2 is a diagram showing the structure of a home/building resource integrating manager according to an exemplary embodiment of the present invention.

FIG. 3 is a diagram showing an example of a procedure of generating building information according to an exemplary embodiment of the present invention.

FIG. 4 is a diagram for describing an example of information managed in a building information storage according to an exemplary embodiment of the present invention.

FIG. 5 is a diagram for describing an example of a form of maintaining individual resources in a resource managing module of a home/building resource integrating manager according to an exemplary embodiment of the present invention.

FIG. 6 is a diagram for describing an example of the structure of a resource object maintained in a resource managing module of a home/building resource integrating manager according to an exemplary embodiment of the present invention.

FIG. 7 is a flowchart showing a procedure performed by a building resource managing module in a home/building resource integrating manager according to an exemplary embodiment of the present invention.

FIG. 8 is a flowchart showing a performing procedure at the time when a resource information managing module receives a message from a lower resource information collector according to an exemplary embodiment of the present invention.

FIG. 9 is a flowchart showing an operation at the time when a resource managing module receives physical space information of a predetermined resource from a user interface or an application program according to an exemplary embodiment of the present invention.

FIG. 10 is a flowchart showing an operation to automatically sense physical space information of a resource object in a resource managing module according to an exemplary embodiment of the present invention.

FIG. 11 is a diagram for describing an example of the structure of a resource relationship object maintained in a resource integrating module of a home/building resource integrating manager according to an exemplary embodiment of the present invention.

FIGS. 12A to 12C are flowcharts showing an operation for a resource integrating module of a home/building resource integrating manager to generate a resource relationship integrated map according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a method and an apparatus for integrating digitalized building information and dynamic resource information in a building according to an exemplary embodiment of the present invention will be described in detail with reference to the accompanying drawings.

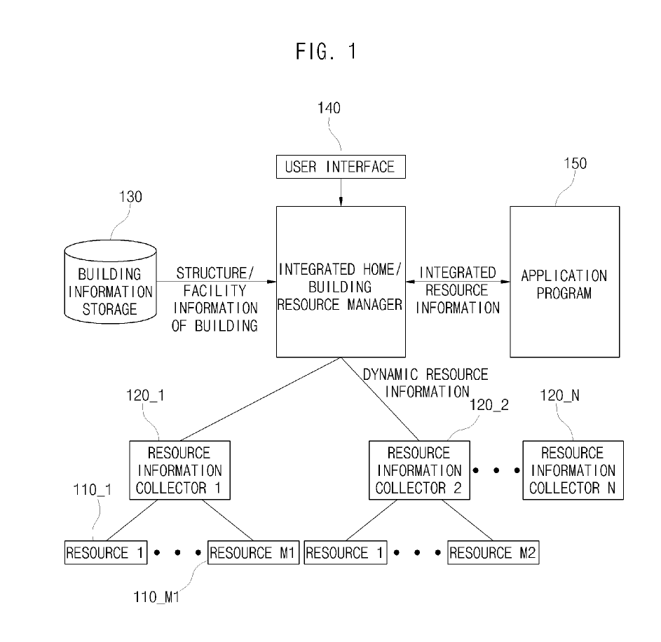

FIG. 1 is a diagram showing an overall configuration of a system for integrating digitalized building information and dynamic resource information in a building according to an exemplary embodiment of the present invention.

As shown in FIG. 1, in the system 100 for integrating digitalized building information and dynamic resource information in a building according to the exemplary embodiment of the present invention, based on an integrated home/building resource manager 200, the integrated home/building resource manager 200 is connected with a building information storage 130 and a plurality of resource information collectors 120_1, 120_2, . . . , 120_N collecting information from resources 110_1, . . . , 110_M1 including a plurality of devices, networks, or services, and a user interface 140 and an application program 150 are connected with each other.

The building information storage 130, which stores digital information associated with the building built up in a design stage or a construction stage, may be built up in the same system as or in a server separated from the integrated home/building resource manager 200. The stored information may be a database or a file type.

The integrated home/building resource manager 200 receives monitoring information of the resources from one or more resource information collectors 120_1, 120_2, . . . , 120_N. In this case, as the collected resource information, all resources that may be management targets in the building, such the devices, the networks, the services, users, and the like may be adopted.

The user interface 140 is used when the users intend to directly input information in the integrated home/building resource manager 200 and may include various setting information and policies for decision making.

The application program 150 includes various application programs capable of providing the services by using integrated resource information acquired from the integrated home/building resource manager 200.

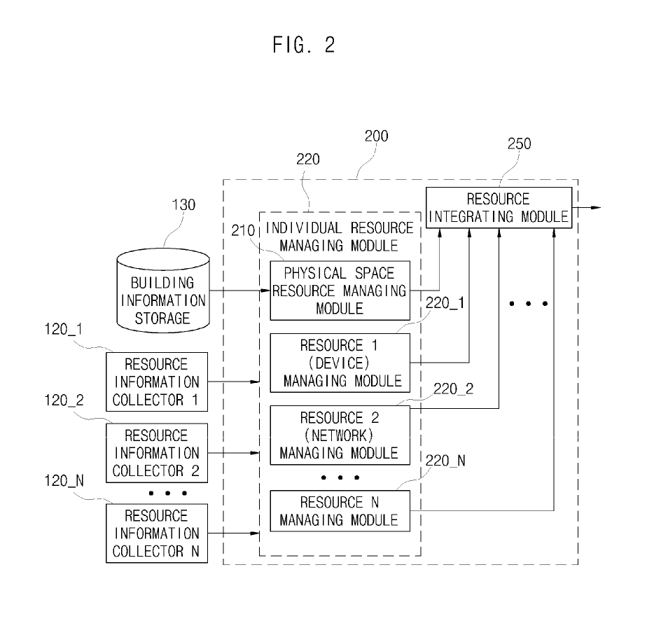

FIG. 2 is a diagram showing the structure of the integrated home/building resource manager 200 according to the exemplary embodiment of the present invention.

As shown in FIG. 2, the integrated home/building resource manager 200 according to the exemplary embodiment of the present invention includes the building information storage 130, an individual resource managing module 220 managing the information acquired from the resource information collectors 120_1, 120_2, . . . , 120_N, and a resource integrating module 250 for integrating building information and collected dynamic resources.

The individual resource managing module 220 may include a physical space resource managing module 210 managing physical space resources stored in the building information storage 130 and a plurality of resource managing modules 220_1, 220_2, . . . , 220_N managing various resources connected with the resource information collectors 120_1, 120_2, . . . , 120_N, that is, resources collected from the devices, the networks, and the like, respectively.

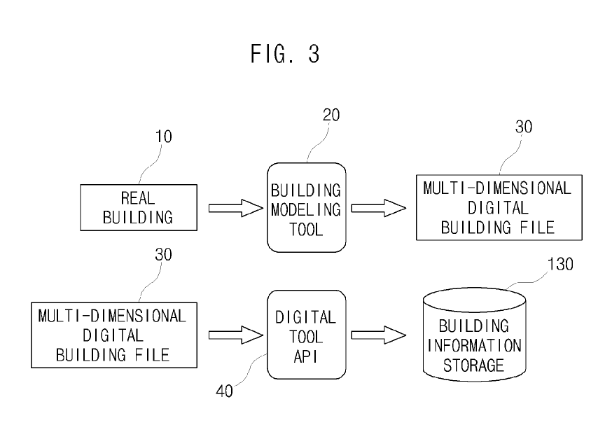

The resource integrating module 250 builds up an integrated map of all the resources and manages the integrated map by performing resource abstraction and relationship analysis of the individual resources managed by the individual resource managing module 220. FIG. 3 is a diagram showing an example of a procedure of generating building information according to an exemplary embodiment of the present invention.

As shown in FIG. 3, a multi-dimensional digital building file 30 is generated by using various kinds of building modeling tools 20 on the basis of a real building 10. The generated multi-dimensional digital building file 30 may include multi-dimensional building information such as structural information, spatial information, and electrical wiring information of the real building. A digital tool API 40 is used in order to extract information on various buildings required by each application program from the generated multi-dimensional digital building information 30 and a specific format is not required therefor and information may be extracted by using various tools that are presently used. The digital information on the buildings extracted through the digital tool API 40 is stored in the building information storage 130 in a table or file type.

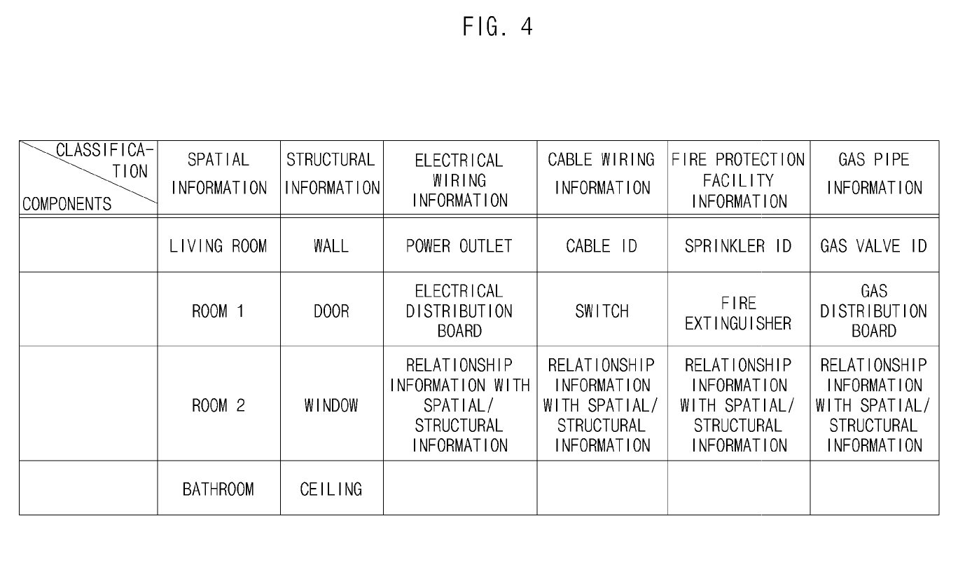

FIG. 4 is a diagram for describing an example of information managed in the building information storage 130 according to an exemplary embodiment of the present invention.

As shown in FIG. 4, the information managed by the building information storage 130 according to the exemplary embodiment of the present invention may be largely classified into spatial information, structural information, electrical wiring information, cable wiring information, fire protection facility information, and gas pipe information. However, FIG. 4 is shown as an example and kinds or types of the information may be variously changed and stored depending on information required by real application programs.

First, the spatial information used in the exemplary embodiment of the present invention represents information that can indicate whether a corresponding space in the real building is physically a living room, a room, or a bathroom. The structural information represents what resources constituting the corresponding space, such as a wall, a door, a window, or a ceiling are.

The electrical wiring information represents layout information of electrical wirings that are provided in the real building. This may be expressed based on relationship information with the spatial and structural information and may be expressed primarily by using the position of an electrical distribution board and a power outlet ID when a plurality of electrical power outlets are provided. In the cable wiring information, the positions and number of switches, and a cable ID are also expressed on the basis of the relationship information with the spatial/structural information.

The fire protection facility information represents the positions and ID information of a fire extinguisher and a sprinkler and the gas pipe information may include various other information such as the position of a gas distribution board and a gas valve ID.

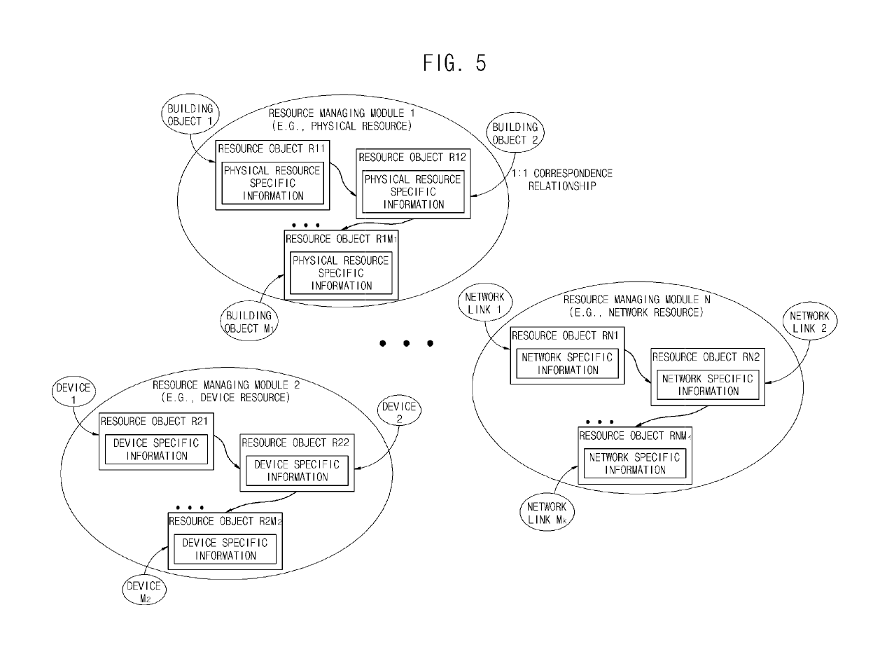

FIG. 5 is a diagram for describing an example of a form of maintaining individual resources in the individual resource managing module 220 of the integrated home/building resource manager 200 according to an exemplary embodiment of the present invention.

As shown in FIG. 5, according to the exemplary embodiment of the present invention, the individual resource managing module 220 maintains a resource object corresponding to each resource and each resource object is generated while being mapped with a resource to be actually managed one to one. For example, in the case of a resource managing module 2 (a device resource managing module), resource objects R21, R22, . . . , R2M₂ mapped onto real device 1, device 2, . . . , device M₂ one to one are generated and maintained, and each resource object reflects a state and an attribute of the real device.

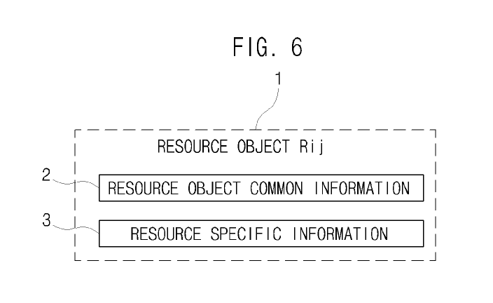

FIG. 6 is a diagram for describing an example of the structures of resource objects maintained in the individual resource managing module 220 of the integrated home/building resource manager 200 according to an exemplary embodiment of the present invention.

As shown in FIG. 6, each resource object 1 is configured to include resource object common information 2 which all the resources should commonly have and resource specific information 3 for each resource.

The resource object common information 2 may include a resource object ID for uniquely distinguishing the corresponding resource object 1 in the integrated home/building resource manager 200, an object type, an object name, and the like. The resource object ID may be allocated by an independent allocation method in the integrated home/building resource manager 200 or the ID may be allocated by receiving a resource ID system provided from the outside.

The resource specific information 3 may include specific information confined to individual resources such as the devices, the networks, physical resources, and the like. Examples of the specific information for the device resource may include a device state, a device hardware address, an access authority, a physical position, and the like, and examples of the specific information for the network resource may include a network link ID, a network link type, a parent/child link, a maximum bandwidth, a link state, an error rate, traffic information, and the like. Further, examples of the specific information for the physical resource may include a coordinate value for an absolute position, a class for determining the spatial information, the structural information, or the facility related information, internal relationship information, and the like.

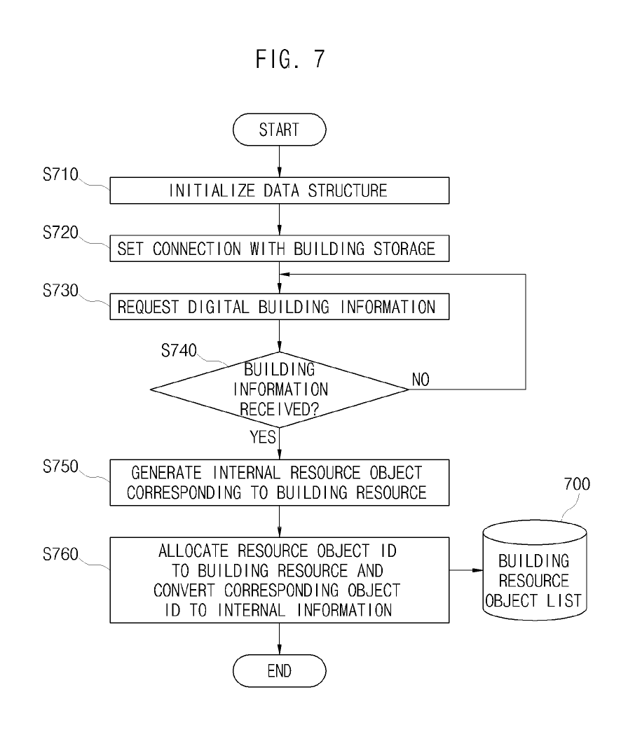

FIG. 7 is a flowchart showing a procedure performed by the building resource managing module 210 in the integrated home/building resource manager 200 according to an exemplary embodiment of the present invention.

As shown in FIG. 7, the building resource managing module 210 according to the exemplary embodiment of the present invention first initializes a data structure (S710) and thereafter, sets connection with the building storage 130 (S720). As described above, the building information storage 130 and the building resource managing module 210 may be physically present in the same system and may be separated from each other.

When connection setting is completed, the building resource managing module 210 requests the digital building information stored in the building information storage 130 (S730) and this operation is continued until the corresponding information is received (S740).

When the receiving of the requested information is completed, the building information managing module 210 generates a resource object corresponding to the building resource one to one in the integrated home/building resource manager 200 (S750) and performs ID allocation and conversion to internal information (S760). The generated building resource object is stored or maintained in various kinds of structures such as a list or a table 700.

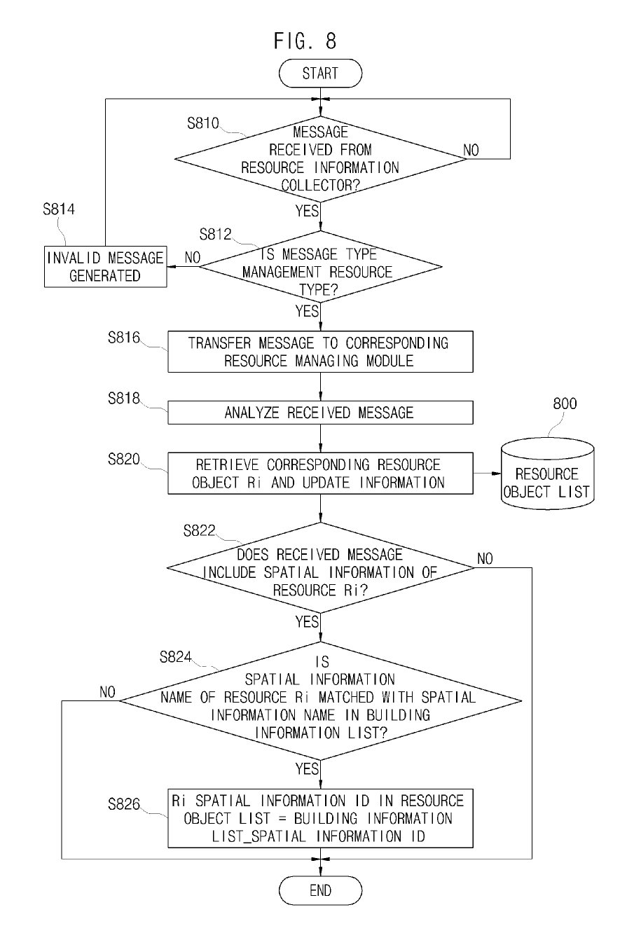

FIGS. 8, 9, and 10 show examples of operational flow for the individual resource managing module 220 of the integrated home/building resource manager 200 to automatically or manually map the physical space information of the resource object with the building information according to an exemplary embodiment of the present invention.

FIG. 8 shows a performing procedure at the time when the resource information managing module 220 receives a message from a resource information collector 120 according to an exemplary embodiment of the present invention. As shown in FIG. 8, the resource information managing module 220 stores resource information such as the device and the network received from the resource information collector 120 for each resource and manages the resource information.

To this end, when the resource information managing module 220 receives the message from the resource information collector 120 (S810), the resource information managing module 220 checks whether a type of the received message is a management resource type (S812). When the received message type is an effective resource type, the resource information managing module 220 transfers the received message to the corresponding resource managing module (S816), and when the received message type is not the effective type, the resource information managing module 220 generates an INVALID error message (S814).

The corresponding resource managing module analyzes the received message (S818) and updates the corresponding information by retrieving the corresponding resource object in a resource object list 800 (S820).

If the received message includes spatial information on the corresponding resource (S822), it is verified whether a spatial information name in the building resource object list 800 that matches a specified spatial information name is present (S824). If the matched name is present, a spatial information ID of a resource object Ri is set as a matched spatial information ID in the building resource object list 800 (S826).

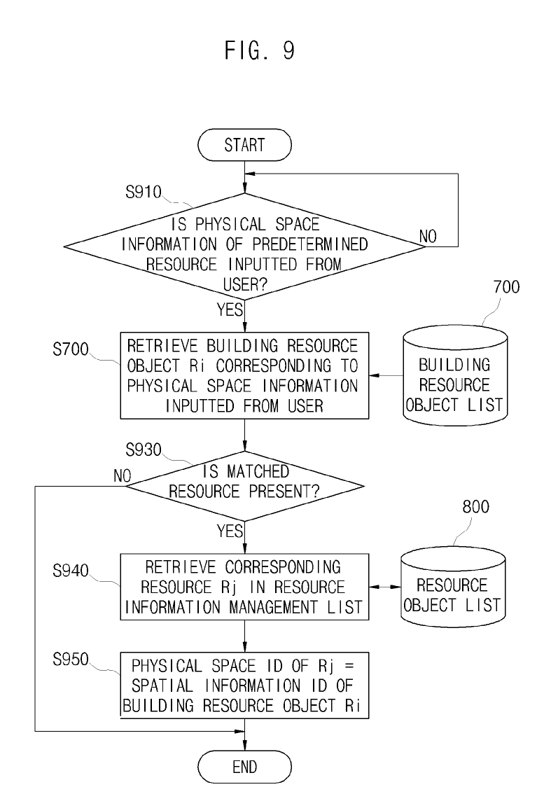

FIG. 9 is a flowchart showing an operation at the time when the individual resource managing module 220 receives physical space information of a predetermined resource from a user interface 140 or an application program 150 according to an exemplary embodiment of the present invention.

As shown in FIG. 9, when the individual resource managing module 220 receives the physical space information on the predetermined resource object from the user interface 140 or the application program 150 (S910), the individual resource managing module 220 retrieves a building resource object Ri corresponding to the received physical space information in a building resource object list 700 (S920).

When a matched building resource object is present as a result of the retrieval (S930), the individual resource managing module 220 retrieves a predetermined resource object Rj in the resource object list 800 (S940). The individual resource managing module 220 sets a physical space ID of the discovered resource object Rj as a result of retrieval as the spatial information ID of the building resource object Ri (S950).

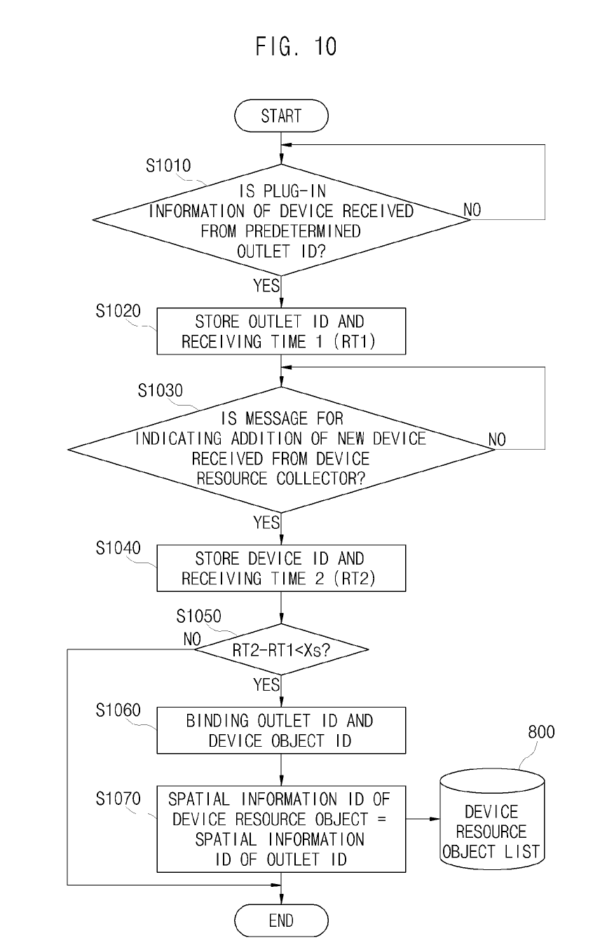

FIG. 10 is a flowchart showing an operation for the individual resource managing module 220 to automatically sense the physical space information of the resource object according to an exemplary embodiment of the present invention. FIG. 10 specifically shows a process for a device resource managing module which is an example of the individual resource managing module 220 to analogize spatial information of a power outlet device of which an electrical power amount can be measured and spatial information of a device which is newly plugged in by using the power outlet ID information of the building resource object list 800. That is, in this process, previously known physical space information of the power outlet ID is mapped onto spatial information of a newly added device resource object.

First, as shown in FIG. 10, when information indicating that the device is plugged in is received from a predetermined power outlet ID (S1010), the power outlet ID and a receiving time 1 (RT1) are stored (S1020).

Thereafter, when a message for notifying that the new device is added is received from the device resource collector 120 (S1030), an ID of the corresponding device and a receiving time 2 (RT2) are stored (S1040).

When a time difference between the RT1 and the RT2 that are collected as above is within a predetermined time Xs (S1050), the power outlet ID and the corresponding device object ID are bound to each other (S1060) and the spatial information ID of the corresponding device object is set as the spatial information ID of the power outlet ID in the device resource object list 800 (S1070).

When the time difference between the RT1 and the RT2 is more than the predetermined time Xs (S 1050), the power outlet ID and the corresponding device object cannot match with each other, and as a result, the process ends.

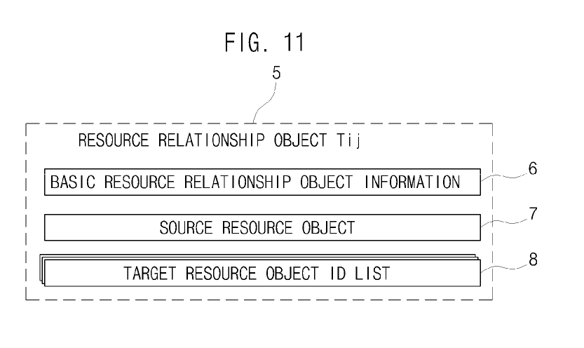

FIG. 11 is a diagram for describing an example of the structures of resource objects maintained in the resource integrating module 250 of the integrated home/building resource manager 200 according to an exemplary embodiment of the present invention.

As shown in FIG. 11, the resource relationship object 5 used in the exemplary embodiment of the present invention is configured to include basic resource relationship object information 6 such as an ID, a name, and a type of a resource relationship object, a source resource object 7, and an ID list 8 of target resource relationship objects. The source resource object 7 indicates the resource object 1 maintained in the individual resource managing module 220 and the target resource object ID list 8 represents a list of other resource objects having a relationship with the source resource object 7.

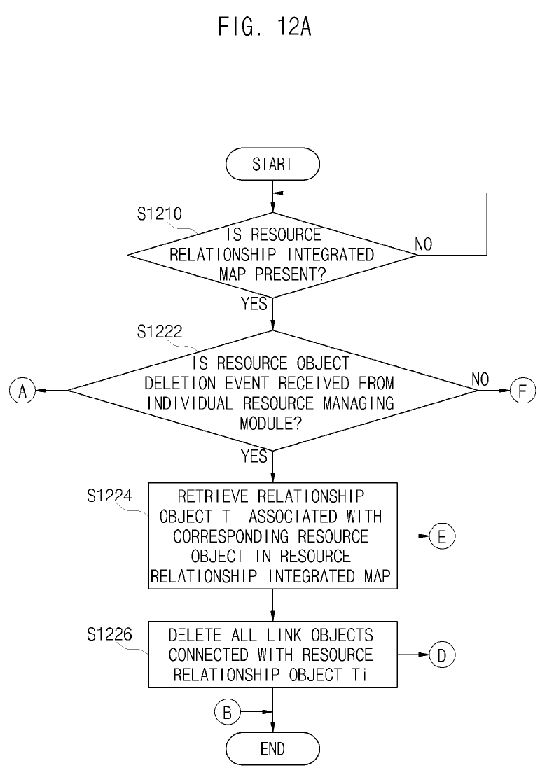

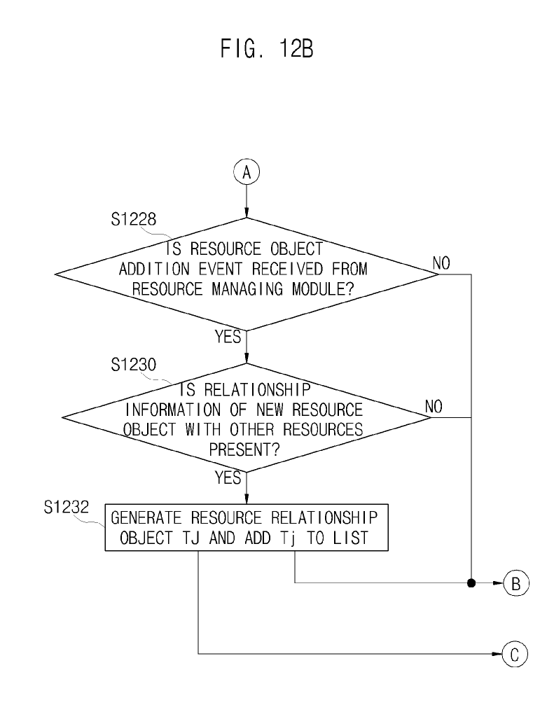

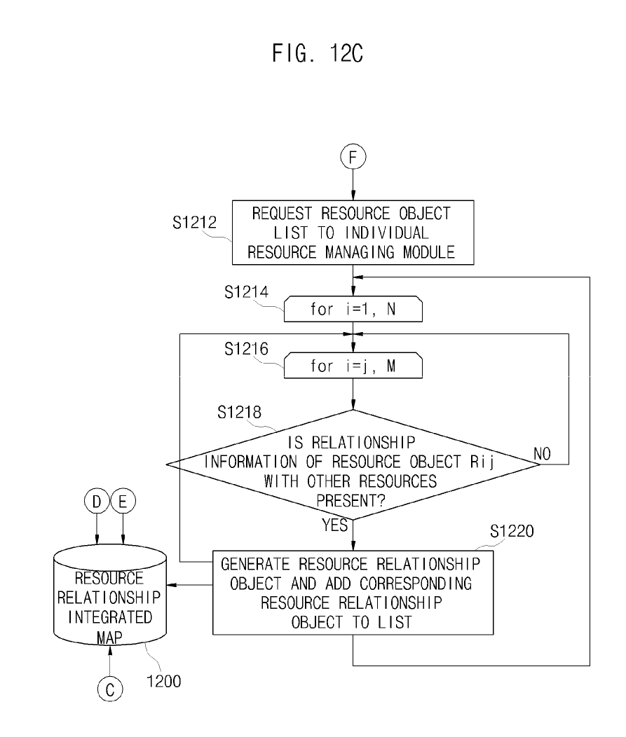

FIGS. 12A to 12C are flowcharts showing an operation for the resource integrating module 250 of the integrated home/building resource manager 200 to generate a resource relationship integrated map according to an exemplary embodiment of the present invention.

Referring to FIGS. 12A to 12C, the resource integrating module 250 first verifies whether the resource relationship integrated map is already present in the resource integrating module 250 (S1210).

When the integrated map is not present, the resource integrating module 250 requests a resource object list to the individual resource managing module 220 (S1212). The resource integrating module 250 collects M₁, . . . , Mₙ resource object information from resource managing modules 1, . . . , N (S1214), respectively (S1216) to examine whether relationship information for other resources is present for each resource object Rij (S1218). For example, the resource integrating module 250 verifies whether spatial information on the building is present with respect to the resource object Rij.

If the relationship information is present, the resource integrating module 250 generates a resource relationship object and adds the generated resource relationship object to the list (S1220). As described above, an initial resource relationship integrated map 1200 is built up by performing steps S1218 and S 1220 repetitively.

If the integrated map is present (S1210), the resource integrating module 250 checks whether an event for notifying that the resource object is deleted is received from the individual resource managing module 220 (S1222). If the deletion event is received, the resource integrating module 250 retrieves a resource relationship object Ti in which the corresponding resource object is designated as the source resource object 7 in the resource relationship integrated map 1200 (S1224). If the resource relationship object Ti is discovered, the resource integrating module 250 finds and deletes the resource relationship object Ti and all link objects connected therewith (S1226).

When the event for notifying the resource object is added is received from the individual resource managing module 220 (S1228), the resource integrating module 250 examines whether relationship information of the new resource object with other resources is present (S1230). If the relationship information with other resources is present, the resource integrating module 250 newly generates a resource relationship object and reflects the generated resource relationship object to the list (S1232).

The resource relationship integrated map 1200 may be built up and maintained in various types such as a tree type, a graph type, or a map type.

Some steps of the present invention may be implemented in a computer-readable recording medium as a computer-readable code. The computer-readable recording media includes all types of recording apparatuses in which data that can be read by a computer system is stored. Examples of the computer-readable recording media may include a ROM, a RAM, a CD-ROM, a CD-RW, a magnetic tape, a floppy disk, an HDD, an optical disk, a magneto-optical storage device, etc., and also include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

According to exemplary embodiments of the present invention, digitalized building information and dynamic monitoring information of internal resources of a building which is a management target can be integrally managed to visually and intuitively manage the internal resources of the building.

Further, by providing a means for determining how the resources are physically or structurally associated with each other, it is possible to provide an integrated resource management method supporting integrated and immediate decision making.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for integrated management of digitalized information and dynamic resources of a building, the apparatus comprising:
a resource information collector collecting dynamic resource information from one or more dynamic resources associated with the building;
an individual resource managing unit receiving digitalized building information from a building information storage to generate a building resource object corresponding to a building resource in the received building information, storing and managing a list of the generated building resource object in a storage device, generating a dynamic resource object corresponding to the dynamic resource information collected by the resource information collector, and storing and managing a list of generated dynamic resource object in the storage device; and
a resource integrating unit connected with the individual resource managing unit to generate and manage a relationship between the building resource object and the dynamic resource object.

2. The apparatus of claim 1, wherein the building information storage is provided inside or outside the building information managing apparatus.

3. The apparatus of claim 1, wherein the dynamic resource includes at least one of a device, a network, and a service.

4. The apparatus of claim 1, further comprising a user input interface receiving the building information or the dynamic resource information from a user.

5. The apparatus of claim 1, wherein each of the building resource object and the dynamic resource object includes resource object common information, which is common for all the resources, and resource specific information, which is unique for each resource.

6. The apparatus of claim 5, wherein the resource object common information includes a resource object ID, an object type, and an object name.

7. The apparatus of claim 5, wherein the resource specific information includes at least one of an absolute position coordinate value, a class, and internal relationship information in the case of the building resource object.

8. The apparatus of claim 5, wherein
the resource specific information includes at least one of a device state, a hardware address, an access authority, and a physical position when the dynamic resource object is a device; and
the resource specific information includes at least one of a network link ID, a link type, a parent/child link, a maximum bandwidth, a link state, an error rate, and traffic information when the dynamic resource object is a network.

9. The apparatus of claim 1, wherein the resource integrating unit performs an automatic or manual mapping of physical space information of the dynamic resource object with the building information.

10. The apparatus of claim 1, wherein the resource integrating unit generates a resource relationship object representing a relationship between two or more resource objects, and stores and manages an integrated map of the generated resource relationship objects in the storage device.

11. The apparatus of claim 1, wherein the resource relationship object includes basic resource relationship object information, a source resource object, and a target resource object list.

12. The apparatus of claim 1, wherein
when a message is received from the resource information collector, the individual resource managing unit analyzes the received message and retrieves the dynamic resource object corresponding to the message from the list of the dynamic resource object and updates the list of the dynamic resource object using information included in the message.

13. The apparatus of claim 12, wherein
when the message includes spatial information of the dynamic resource object, the resource integrating unit verifies whether a spatial information name corresponding to a name of the spatial information is present in the list of the building resource object, and, when the corresponding spatial information name is present, the resource integrating unit sets an spatial information ID of the dynamic resource object as the spatial information ID matched in the list of the building resource object.

14. The apparatus of claim 1, wherein
when physical space information of a predetermined dynamic resource object is input from outside of the individual resource managing unit, the individual resource managing unit verifies whether a building resource object corresponding to the physical space information is present in the list of the building resource object, and, when the corresponding building resource object is present, the individual resource managing unit retrieve the predetermined resource object from the list of the dynamic resource object and set a physical space ID of the retrieved predetermined resource object as the spatial information ID of the building resource object.

15. A method for integrated management of digitalized information and dynamic resources of a building, the method comprising:
receiving digitalized building information from a building information storage;
generating a building resource object corresponding to a building resource in the received building information and storing a list of the generated building resource object in a storage device;
collecting dynamic resource information from one or more dynamic resources associated with the building;
generating a dynamic resource object corresponding to the collected dynamic resource information and storing a list of the generated dynamic resource object in the storage device; and
generating a resource relationship object representing a relationship between the building resource object and the dynamic resource object and storing an integrated map of the generated resource relationship object in the storage device.

16. The method of claim 15, wherein each of the building resource object and the dynamic resource object includes resource object common information, which is common for all the resources, and resource specific information, which is unique for each resource.

17. The method of claim 15, wherein the resource relationship object includes basic resource relationship object information, a source resource object, and a target resource object list.

18. The method of claim 15, further comprising automatically or manually mapping physical space information of the dynamic resource object with the building information.
